(19) United States
(12) Patent Application Publication
(10) Pub. No.: US 2016/0173937 A1
(43) Pub. Date: Jun. 16, 2016

(54) METHODS AND DEVICES FOR MEDIA CASTING MANAGEMENT AMONG MULTIPLE MEDIA CASTING DEVICES SUPPORTING DIFFERENT MEDIA CASTING PROTOCOLS

(71) Applicant: MediaTek Inc., Hsin-Chu (TW)

(72) Inventors: Cheng-Wei SHIH, Kaohsiung City (TW); Yung-Tso CHEN, Taipei City (TW); Hsiao-Wen CHEN, New Taipei City (TW); Chia-Feng YEH, Tainan City (TW)

(21) Appl. No.: 14/567,140

(22) Filed: Dec. 11, 2014

(51) Int. Cl. H04N 21/436; H04N 21/472; H04N 21/45; H04N 21/4363; H04N 21/475

(52) U.S. Cl. CPC H04N 21/43615; H04N 21/43637; H04N 21/4755; H04N 21/4524; H04N 21/472; H04N 21/4532

(57) ABSTRACT

A method for managing media content casting among media casting devices supporting different media casting protocols for use in a device wirelessly connected to the media casting devices is provided. The method includes the following steps. A request indicating media content to be casted is first received. The media casting devices are scanned to determine a list of available devices for media content casting according to the predetermined preferences. The list of available devices is displayed on a display for selection. A first media casting protocol corresponding to a first selected media casting device is determined and the media content is transmitted to the first selected media casting device by the first media casting protocol.

### BACKGROUND OF THE INVENTION

1. Field of the Invention

The invention relates to media casting management, and more precisely, to methods and devices for media casting management among multiple media casting devices supporting different media casting protocols.

2. Description of the Related Art

With advances in technology, media casting functions and supported devices are widely used nowadays, e.g. Chormecast, Miracast, AirPlay and so on. A user may play media content via an applications user interface (UI) and dedicated operations provided by a media casting device that supports a media casting protocol, such as an AIRPLAY compatible protocol. However, users may need to play media content via many different applications user interface (UI) and difficult operates if there are many devices that support media casting function, dramatically reducing user satisfaction. It is not convenience for user to cast media to different devices. If there are many devices that support media casting, user needs to switch to each different applications for casting different media content since each application has different UI and usage flow. Therefore, it is difficult to find a best device for casting. Moreover, user may not understand the difference of each device. Currently, there is no good way to search a best device for casting automatically.

It is therefore desired to provide methods and devices for media casting management to search a best device for casting automatically and increase user satisfaction.

### BRIEF SUMMARY OF THE INVENTION

An embodiment of the invention provides a method for managing media content casting among media casting devices supporting different media casting protocols for use in a device wirelessly connected to the media casting devices. The method comprises the following steps. A request indicating media content to be casted is first received. The media casting devices are scanned to determine a list of available devices for media content casting according to predetermined preferences. The list of available devices is displayed on a display for selection. A first media casting protocol corresponding to a first selected media casting device is determined and the media content is transmitted to the first selected media casting device by the first media casting protocol.

Another embodiment of the invention provides a device. The device comprises a storage device, a processing unit and a display unit. The storage device stores predetermined preferences. The processing unit provides an interface integrating with a plurality of media casting protocols, receives a media content to be casted, scans a plurality of media casting devices to determine a list of available devices for media content casting according to the stored predetermined preferences via the interface, and displays the list of available devices via the display unit for selection. The processing unit further determines a first media casting protocol corresponding to a first selected media casting device and transmits the media content to the first selected media casting device by the first media casting protocol.

### BRIEF DESCRIPTION OF THE DRAWINGS

The invention can be more fully understood by reading the subsequent detailed description and examples with reference to the accompanying drawings, wherein:

FIG. 1 is a schematic diagram illustrating an embodiment of a device according to the invention;

FIG. 2 is a flowchart showing an embodiment of a method for managing media content casting among media casting devices that support different media casting protocols according to the invention;

FIG. 3 is a flowchart showing another embodiment of a method for managing media content casting among media casting devices that support different media casting protocols according to the invention;

FIG. 4 is a schematic diagram illustrating an embodiment of a user interface according to the invention; and

FIG. 5 is a diagram illustrating a scenario that a device is wirelessly connected to multiple media casting devices that support media casting functions according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

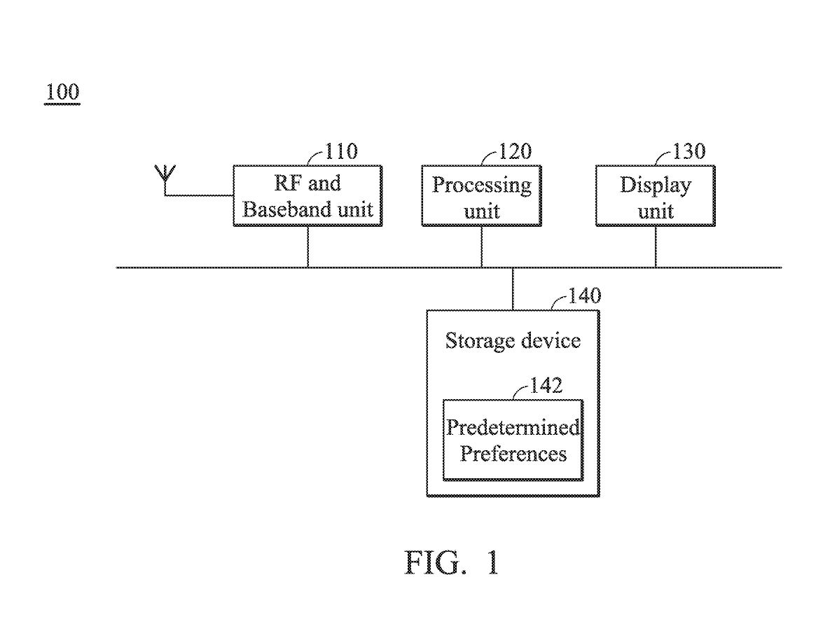

The invention will now be described with reference to FIGS. 1 through 5, which generally relate to media casting management among multiple media casting devices supporting same or different media casting protocols. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

The embodiments of the invention provide methods for managing media content casting among media casting devices supporting various media casting protocols for use in a device wirelessly connected to the media casting devices, which provides a media casting manager framework integrating protocols and related software of all casting device that is available for support, e.g. Chormecast, Miracast, AirPlay . . . etc, to dynamically provide a best choice list of available casting devices for media content casting for user selection according to predetermined user preferences and provide refined casting device listing based on user content and choices of constraints, dramatically increasing user satisfaction.

In some embodiments, the invention can also be provided a user interface for a user to configure predetermined preferences, allowing the user to determine which media casting device should be used to cast media content flexibly.

FIG. 1 is a schematic diagram illustrating an embodiment of a device 100 according to the invention. The device 100 may be a portable device, such as a mobile phone, a smart phone, or a PDA. The device 100 can be wirelessly connected to a number of media casting devices or media source devices (not shown) (e.g. digital TVs or audio systems) that support different media casting protocols, e.g. Chormecast compatible protocol, Miracast compatible protocol, AirPlay compatible protocol and so on, for media content casting.

The device 100 comprises a radio frequency (RF) and baseband unit 110, a processing unit 120, a display unit 130 and a storage device 140. The RF and baseband unit 110 receives signals from and transmits signals to a current associated network. It is to be understood that integrating the processing unit 120 into the RF and baseband unit 110 is also available. The RF and baseband unit 110 may be coupled to one or more antennas (not shown) and may allow communications with one or more additional devices, computers and/or servers using a wireless network. The device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto. The processing unit 120 may be one or more data processors, image processors and/or central processors, which are capable of executing one or more types of computer readable medium stored in the storage device 140 such as a memory.

The display unit 130 (e.g. a LCD) can display related data, such as user interfaces, notes, and others. It is understood that, in some embodiments, the display unit 130 may be integrated with a touch-sensitive device to form a touch-sensitive display unit. The touch-sensitive device has a touch-sensitive surface comprising sensors in at least one dimension to detect contact and movement of an input tool near or on the touch-sensitive surface.

The storage device 140 may store related data, and provide data to the display unit 130 for display. The storage device 140 may be a volatile or non-volatile storage device, such as a built-in memory, or an external memory card. The storage device 140 may include one or more types of computer readable medium. The storage device 140 may include high-speed random access memory (e.g. SRAM or DRAM) and/or non-volatile memory, such as one or more magnetic disk storage devices, one or more optical storage devices, and/or flash memory. The storage device 140 may store predetermined preferences 142 which contain parameters or constraints for determining which media casting device should be included to generate a choice list of available casting devices. The predetermined preferences may further comprise information regarding ordering rules for ordering the found available casting devices and/or information regarding filtering rules for filtering out a set of available casting devices from the found available casting devices. The ordering rules may indicate that information of how to arrange the list of available casting devices and the list of available casting devices can be ordered according to the ordering rules. The filtering rules may indicate that information of which casting device should be selected or be not selected and a set of casting devices may be filtered based on the filtering rules.

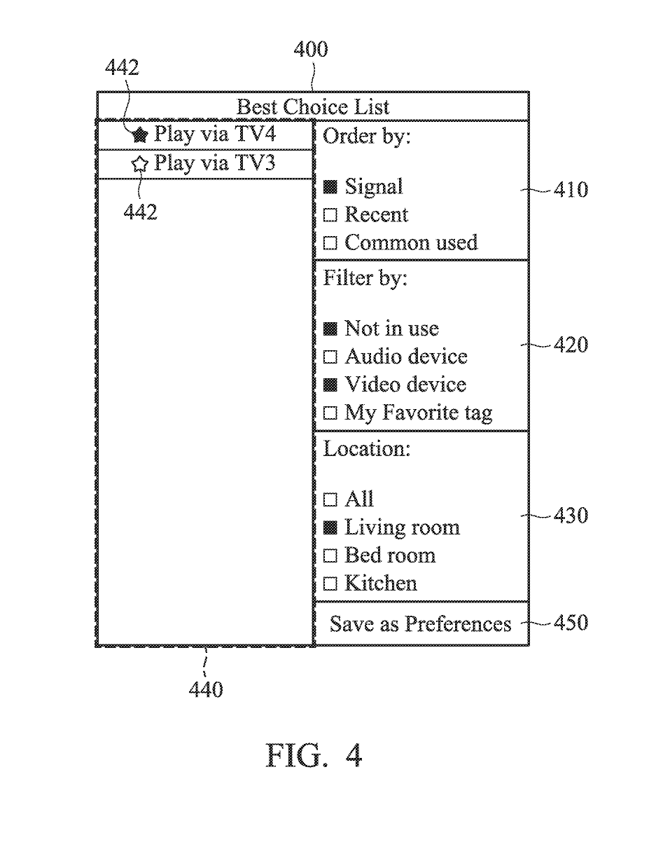

In some embodiments, the ordering rules may comprise, for example but not limited to, one or more of the following rules: ordering by user preference; ordering by detected signal strength; ordering by recent history; and ordering by using frequency, and the list is further ordered according to one or more of the following parameters: user preference, detected signal strength, recent history and/or a using frequency. In some embodiments, the predetermined preferences may comprise, for example but not limited to, one or more of following parameters: a location of a media casting device, a media content type, a device status indicating whether the device is being in used and/or a specific tag and the filtering rules may comprise, for example but not limited to, one or more of the following rules: filtering by locations of the media casting devices; filtering by a content type of the media content; filtering by statuses of the media casting devices; and filtering by a specific tag. A user may configure the preferences including the ordering rules and/or the filtering rules by a user interface (e.g. user interfere 400 of FIG. 4) provided by the device 100.

In some embodiments, a user may input or configure user preferences by a user interface provided by the device 100 and store them to the storage device 140 and the list of available casting devices being displayed can be determined based on the user preferences predefined by the user. The user interface is provided for the user to configure or change the user preferences including the ordering rules and/or the filtering rules.

Referring to FIG. 4, which shows an exemplary user interface for configuring the user preferences according to the invention. As shown in FIG. 4, the user interface 400 may comprise a number of fields 410-450, wherein the field 410 is used for configuring parameters of the ordering rules, the fields 420 and 430 are used for configuring parameters of the filtering rules, the field 440 is used for displaying the list of available casting devices and the field 450 is used for saving the configurations to the storage device 140 to be served as the user preferences for further processing. The field 440 may further comprise a favorite tag 442 which is used for configuring the responsive device as a favorite device. The user can input or configure the user preferences by suitable operations via the user interfaces shown in the FIG. 4. For example, the user may select or unselect one or more parameters shown in the field 410 to configure one or more ordering rules and/or select or unselect one or more parameters shown in the field 420 and/or field 430 to configure one or more filtering rules via the user interfaces 400 shown in the FIG. 4 or alter the parameter selections on the fields 410-430 to change the user preferences via it.

The processing unit 120 (e.g. a hardware processor or a CPU) performs methods for managing media casting among multiple media casting devices that support various media casting protocols of the present invention, which will be discussed further in the following paragraphs. To be more specific, the processing unit 120 can provide a media casting manager framework integrating protocols and related software of all casting device that is available for support, e.g. a Chormecast compatible protocol, a Miracast compatible protocol, a AirPlay compatible protocol and other media casting protocols, and communicate with the multiple media casting devices using respective media casting protocols via the media casting manager framework to manage the multiple media casting devices for media content casting.

Several embodiments of methods for managing media content casting among media casting devices that support different media casting protocols based on media content and user preferences are provided.

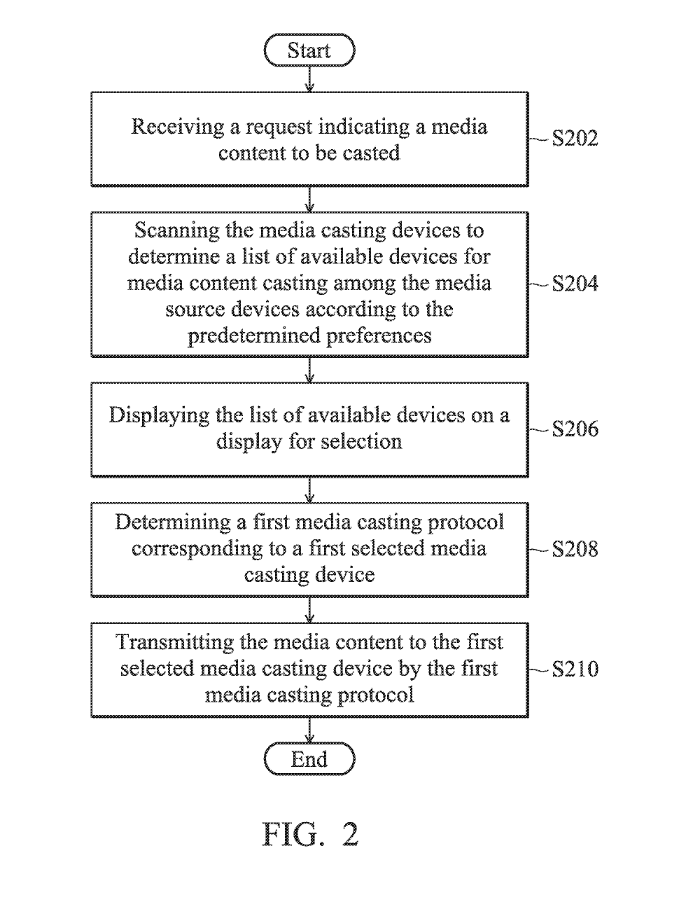

FIG. 2 is a flowchart showing an embodiment of a method for managing media content casting among media casting devices that support different media casting protocols according to the invention. The method can be used for a device, such as a PDA, a smart phone, a mobile phone, a mobile internet device, a laptop computer, a tablet computer or other similar mobile computing device. For example, the method can be performed by the processing unit 120 of the device 100 shown in FIG. 1.

When a user wishes to cast a specific media content (e.g. video file, audio file or a streaming content), in step S202, the device 100 receives a request for media content casting from the user. The request may indicate a media content (e.g. a video file) to be casted.

Then, in step S204, the device 100 scans all of the media casting devices to determine a list of available devices for media content casting among the media casting devices according to predetermined preferences provided by the user. Scanning of available devices can be achieved by scanning all of the media casting devices based on the predetermined preferences to determine a list of available devices for media content casting among the media casting devices. The user may configure the preferences (e.g. user preferences) including the ordering rules and/or the filtering rules by a user interface (e.g. user interfere 400 of FIG. 4) provided by the device 100.

The user preferences may further comprise information regarding ordering rules for ordering the found available casting devices and/or information regarding filtering rules for filtering out a set of available casting devices from the found available casting devices. In some embodiments, the ordering rules may comprise, for example but not limited to, one or more of the following rules: ordering by user preference; ordering by detected signal strength; ordering by recent history; and ordering by using frequency, and the list is further ordered according to one or more of the following parameters: user preference, detected signal strength, recent history and/or a using frequency. In some embodiments, the predetermined preferences may comprise, for example but not limited to, one or more of following parameters: a location of a media casting device, a media content type, a device status indicating whether the device is being in used and/or a specific tag and the filtering rules may comprise, for example but not limited to, one or more of the following rules: filtering by locations of the media casting devices; filtering by a content type of the media content; filtering by statuses of the media casting devices; and filtering by a specific tag. The filtering rules and/or ordering rules included in the user preferences may further be applied to the found available devices to generate a filtered and/or ordered list of available devices to be displayed.

After applying the filtering rules and/or ordering rules included in the user preferences to the found available devices, in step S206, the device 10 displays a list of available devices on the display (e.g. the display unit 130) for selection. Accordingly, the user may select one from the list of available devices as a casting device for media casting. Upon receiving the user selection, the device 100 may then determine, in step S208, a first media casting protocol corresponding to a first selected media casting device and transmit, in step S210, the media content to the first selected media casting device by the first media casting protocol to cast the media content via the first selected media casting device. For example, if the first selected media casting device supports an AirPlay compatible protocol, the device 100 may determine the first media casting protocol as the AirPlay compatible protocol and transmit the media content to the first selected media casting device using the AirPlay compatible protocol to cast the media content via the first selected media casting device. In one embodiment, the user preferences may only comprise the ordering rules and the list of available media casting devices can further be ordered according to the ordering rules and then the ordered list of available media casting devices will be displayed for selection. The user may select a casting device for media casting from the ordered list of available media casting devices.

For example, when the parameter of ordering rule is detected signal strength, the device may order or sort the found available media casting devices based on the detected signal strengths corresponding to the found available media casting devices. In this case, the device with stronger signal strength will have higher ordering priority. When the ordering rules include a parameter of “recent history”, the device which is being most recently used will have higher ordering priority. When the ordering rules include a parameter of “common used”, the device which is being most frequently used will have higher ordering priority.

In another embodiment, the user preferences may only comprise the filtering rules and the list of available media casting devices can further be filtered according to the filtering rules and then the filtered list of available media casting devices will be displayed for user selection. The user may select a casting device for media casting from the filtered list of available media casting devices.

For example, when the parameters of filtering rules include a location parameter “location=living room”, the device can filter out devices only placed in living room. When the parameters of filtering rules include a content type parameter “content type=audio”, the device can filter out audio devices only. When the parameters of filtering rules include a device status parameter “device status=not in use”, the device can filter out devices that are not being used. When the parameters of filter rule include a user favorite tag parameter “user favorite tag=set”, the device can filter out devices that have user favorite tag.

In yet another embodiment, the predetermined preferences may comprise both the filtering rules and the ordering rules and the list of available media casting devices can be ordered and filtered according to the filtering rules and the ordering rules. Then, the filtered and ordered list of available media casting devices will be displayed for selection. In one example, the list of available media casting devices can first be ordered based on the ordering rules and the ordered list of available media casting devices can further be filtered based on the filtering rules to generate the filtered and ordered list of available media casting devices for displaying. In another example, the list of available media casting devices can first be filtered based on the filtering rules and the filtered list of available media casting devices can further be ordered based on the ordering rules to generate the filtered and ordered list of available media casting devices for displaying. For example, when the parameters of ordering rules include detected signal strength and the parameters of filtering rules include a device status of “not in use”, the device may filter out/select the media casting devices that are not being in used from the found available media casting devices and order or sort the media casting devices that are not being in used based on responsive detected signal strengths thereof to generate a choice list for displaying. The user may select a casting device for media casting from the filtered and ordered list of available media casting devices.

In some embodiments, the user may change the preferences such as the ordering rules and/or the filtering rules via the user interface (e.g. 400 of FIG. 4) so that the device 100 may detect a changed preferences via the user interface and then automatically rescan the media casting devices to re-determine the list of available media casting devices for media content casting according to the changed preferences.

In some embodiments, the user may select a second media casting device and the device 100 may determine a second media casting protocol corresponding to the second selected media casting device and then transmit the media content to the second selected media casting device by the second media casting protocol, wherein the second media casting protocol is different from the first media casting protocol, such as a Chromecast compatible protocol. For example, if the second selected media casting device supports an Chromecast compatible protocol, the device 100 may determine the second media casting protocol as the Chromecast compatible protocol and transmit the media content to the second selected media casting device using the Chromecast compatible protocol to cast the media content via the second selected media casting device.

In some embodiments, the list of available devices may comprise one or more available media casting devices. Thus, the device 100 may further determine whether the list of available devices contains only one device, and if so, automatically/directly configure the only one device to be the casting device. If the list of available media casting devices contains more than one media casting device, the device 100 applies the ordering rules and/or the filtering rules to the found devices to determine a new list of available devices for media content casting according to the predetermined preferences.

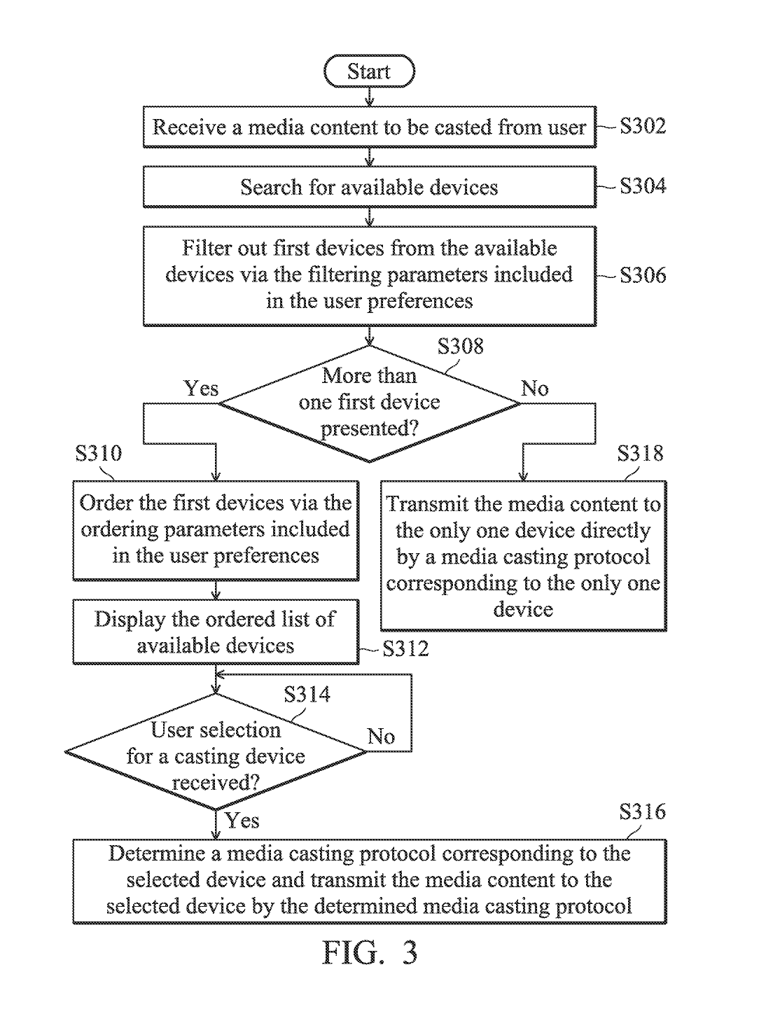

FIG. 3 is a flowchart showing another embodiment of a method for managing media content casting among media casting devices that support different media casting protocols according to the invention. The method can be used for a device, such as a PDA, a smart phone, a mobile phone, a mobile internet device, a laptop computer, a tablet computer or other similar mobile computing device. For example, the method can be performed by the processing unit 120 of the device 100 shown in FIG. 1. In this embodiment, it is assumed that the user preferences contain both a set of filtering parameters for the filtering rules and a set of ordering parameters for ordering rules which are pre-stored in the storage device 140.

First, the device 100 receives a media content (e.g. a video file) to be casted (step S302) and searches for available devices accordingly (step S304). For example, the device 100 may search all of the devices according to predetermined preferences such as user preferences. Then, the device 100 filters out first devices from the available devices via the filtering parameters included in the user preferences (step S306). For example, the device 100 may filter out/select the devices that are not being in used from the found available devices based on the parameters of filtering rules include a device status of “not in use”.

As the filtered first devices (i.e. the filtered list of available devices) may comprise one or more first devices, thus, the device 100 further determines whether the filtered list of available devices contains more than one first device (step S308). If the filtered list of available devices contains more than one first device (Yes in step S308), the device 100 applies the ordering rules to order all of the first devices via the ordering parameters of the ordering rules included in the user preferences to determine a new list of available devices for media content casting accordingly (S310) and then displays the ordered list of available devices on the display for selection (S312). For example, when the parameters of ordering rules include detected signal strength and the parameters of filtering rules include a device status of “not in use”, the device may filter out/select the first devices that are not being in used from the available devices and order or sort the first devices that are not being in used based on responsive detected signal strengths thereof to generate a choice list for displaying.

Accordingly, the user may select a casting device for media casting from the displayed list of available devices. The device 100 then determines whether a user selection for a casting device has received (step S314). If not, step S314 is repeated. If so (Yes in step S314), the device 100 then determine a first media casting protocol corresponding to a first selected media casting device and transmit the media content to the first selected media casting device by the first media casting protocol to cast the media content via the first selected media casting device (step S316). For example, if the first selected media casting device supports an AirPlay compatible protocol, the device 100 may determine the first media casting protocol as the AirPlay compatible protocol and transmit the media content to the first selected media casting device using the AirPlay compatible protocol to cast the media content via the first selected media casting device.

If the filtered list of available devices contains only one device (No in step S308), the device 100 automatically configures the only one device to be the casting device and transmits the media content to the only one device directly by a media casting protocol corresponding to the only one device to cast the media content via this only one device (step S318).

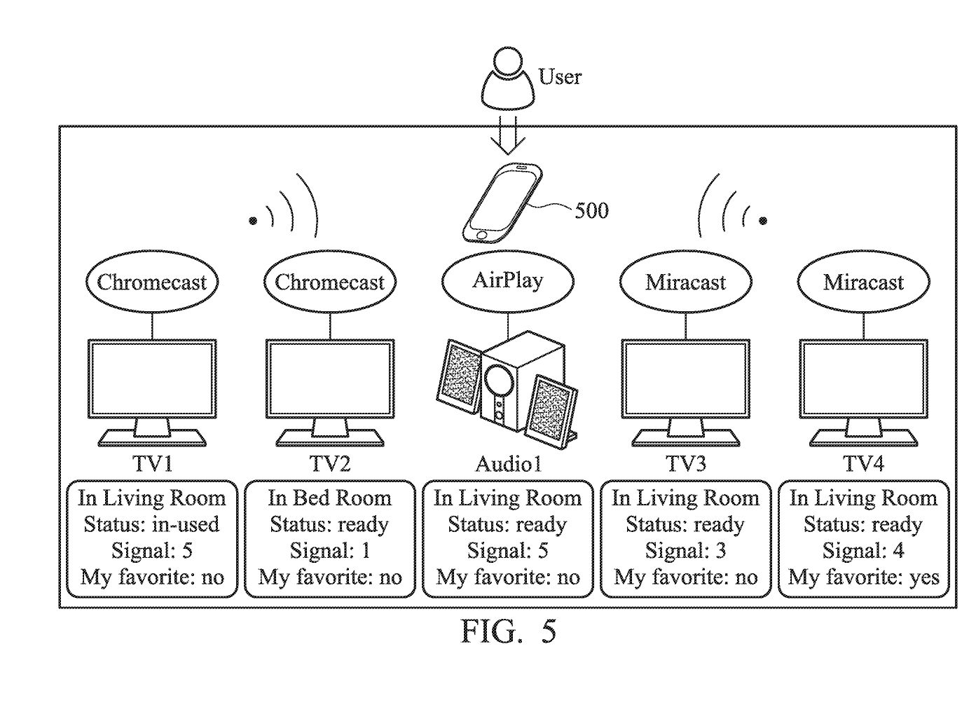

For example, refers to FIG. 5, which is a diagram illustrating a scenario that a device is wirelessly connected to multiple media casting devices that support media casting functions according to an embodiment of the invention. In a scenario as shown in FIG. 5, there are total five media casting devices TV1, TV2, TV3, TV4 and Audio1 that support media casting functions and a device 500 operable by a user is wirelessly connected to the five media casting devices, wherein the devices TV1 and TV2 are using the Chromecast compatible protocol for media casting, the devices TV3 and TV4 are using the Mirrorcast compatible protocol for media casting and the device Audio1 is only device using the Airplay compatible protocol for media casting. In this embodiment, the device 500 (e.g. a mobile phone) is similar to the device 100 of FIG. 1. It is assumed that the device TV1 is placed in the living room with a signal strength of “5”, a device status of “in-use” and no favorite tag, the device TV2 is placed in the bedroom with a signal strength of “1”, a device status of “ready” (i.e. not in use) and no favorite tag, the device TV3 is placed in the living room with a signal strength of “3”, a device status of “ready” and no favorite tag, the device TV4 is placed in the living room with a signal strength of “4”, a device status of “ready” and a favorite tag, and the device Audio1 is placed in the living room with a signal strength of “5”, a device status of “ready” and a favorite tag. It is also assumed that the predetermined preferences are configured to comprise the ordering rules and the filtering rules as shown in FIG. 4, wherein the ordering rules indicate to order the devices by signal strengths and the filtering rules indicate to filter out the device which is a video device placed in the living room and is not being in used.

When the user enters the user preferences as above via the user interface 400 shown in FIG. 4 and selects a video content for media casting, the device 500 searches all of the five devices and finds out the devices TV3 and TV4 as available devices according to the preferences. Then, according to the ordering rules, the device TV 4 with higher signal strength will have a higher ordering priority than that of the device TV3 and thus the two available devices are ordered from the device TV4 to the device TV3. Thereafter, according to the filtering rules, as both the devices TV3 and TV4 are video devices placed in the living room and not being in used, the two available devices are filtered. Therefore, the choice list of available devices containing the device TV4 and the device TV3 will be displayed on the display of the device 500 to be selected by the user. Then, the user can simply select either the device TV4 or TV3 from the displayed choice list and the video content can then automatically be casted via the selected device TV4 or TV3.

The described embodiments for managing media content casting, or certain aspects or portions thereof, may be practiced in logic circuits, or may take the form of a program codes (i.e., instructions) embodied in tangible media, such as floppy diskettes, CD-ROMS, hard drives, or any other machine-readable storage medium, wherein, when the program codes are loaded into and executed by a machine, such as a smart phone, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor (e.g. 120 of FIG. 1), the program codes combine with the processor to provide a unique apparatus that operate analogously to specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

1. A method for managing media content casting among media casting devices supporting different media casting protocols for use in a device wirelessly connected to the media casting devices, comprising:
receiving a request indicating a media content to be casted;
scanning the media casting devices to determine a list of available devices for media content casting according to predetermined preferences, wherein the list of available devices at least comprise a first media casting device supporting a first media casting protocol and a second media casting device supporting a second media casting protocol other than the first media casting protocol;
displaying the list of available devices on a display for selection;
receiving a selection signal indicating a selected media casting device which is selected from the first media casting device and the second media casting device;
selecting from the first and second media casting protocols according to the selected media casting device;
and
transmitting the media content to the selected media casting device by the selected media casting protocol.

2. The method of claim 1, wherein the predetermined preferences comprise one or more of following parameters: a location of a media casting device, a media content type, a device status indicating whether the device is being in used and/or a specific tag.

3. The method of claim 1, wherein the list is further ordered according to one or more of the following parameters: user preference, detected signal strength, recent history and/or a using frequency.

4. The method of claim 1, wherein the displaying step further comprises:
providing a user interface for the user to change the preferences.

5. The method of claim 4, further comprising:
detecting a changed preferences via the user interface; and
automatically rescanning the media casting devices to re-determine the list of available devices for media content casting according to the changed preferences.

6. The method of claim 1, wherein the first media casting protocol is one of the following media casting protocols: Chromecast, AirPlay and/or Miracast compatible protocols.

7. The method of claim 1, further comprising:
determining whether the list of available media casting devices contains only one media casting device; and
if so, automatically configuring the only one media casting device to be the casting device.

8. (canceled)

9. A device, comprising:
a storage device, storing predetermined preferences;
a display unit; and
a processing unit, providing an interface integrating with a plurality of media casting protocols, receiving a media content to be casted, scanning a plurality of media casting devices to determine a list of available devices for media content casting according to the stored predetermined user preferences via the interface, and displaying the list of available devices via the display unit for selection,
wherein the list of available devices at least comprise a first media casting device supporting a first media casting protocol and a second media casting device supporting a second media casting protocol other than the first media casting protocol and the processing unit further receives a selection signal indicating a selected media casting device which is selected from the first media casting device and the second media casting device, selects from the first and second media casting protocols according to the selected media casting device and transmits the media content to the selected media casting device by the selected media casting protocol.

10. The device of claim 9, wherein the predetermined preferences further comprise one or more of following parameters: a location of a media casting device, a media content type, a device status indicating whether the device is being in used and/or a specific tag.

11. The device of claim 9, wherein the list is further ordered according to one or more of the following parameters: user preference, detected signal strength, recent history and/or a using frequency.

12. The device of claim 9, further comprising a user interface provided for the user to change the preferences.

13. The device of claim 12, wherein the processing unit further detects a changed preferences via the user interface and automatically rescans the media casting devices to re-determine the list of available devices for media content casting according to the changed preferences.

14. The device of claim 9, wherein the first media casting protocol is at least one of the following media casting protocols: Chromecast, AirPlay and/or Miracast compatible protocols.

15. The device of claim 9, wherein the processing unit further determines whether the list of available devices contains only one media casting device, and if so, automatically configures the only one media casting device to be the casting device.

16. (canceled)
